(19) United States
(12) Patent Application Publication
(10) Pub. No.: US 2011/0040616 A1
(43) Pub. Date: Feb. 17, 2011

(54) SPONSORED SEARCH BID ADJUSTMENT BASED ON PREDICTED CONVERSION RATES

(75) Inventors: Ashvin Kannan, Sunnyvale, CA (US); Benjamin Rey, Versailles (FR)

Correspondence Address: Mauriel Kapouytian & Treffert LLP, 151 First Avenue, #23, New York, NY, 10003, US

(73) Assignee: Yahoo! Inc., Sunnyvale, CA (US)

(21) Appl. No.: 12/541,453

(22) Filed: Aug. 14, 2009

(51) Int. Cl. G06Q 30/00; G06F 15/18; G06N 5/02; G06F 17/30

(52) U.S. Cl. 705/14.45; 705/14.71; 706/12; 706/52; 707/E17.014

(57) ABSTRACT

Methods and systems are provided for adjusting an advertiser bid, in a sponsored search auction, in connection with one or more advertisements to be served in connection with keyword queries, the bid being associated with one or more keyword phrases. The bid is adjusted based on a predicted conversion rate associated with an advertisement served in connection with a match between a keyword query and the one or more keyword phrases. A bid may be decreased for a match with a lower predicted conversion rate than a comparison predicted conversion rate such as a normalized average predicted conversion rate.

### BACKGROUND

Sponsored search advertising includes serving of advertisements in connection with computer user-entered keyword queries. In a sponsored search marketplace, auctions may be available in which advertisers may place bids. The bids relate to keyword phrases, which may include one or more terms, or to groups of keyword phrases. A bid may specify or allow determination of an amount of money that an advertiser is willing to pay per user click on a specified advertisement served in connection with a user keyword query that matches a keyword phrase associated with the advertiser's bid. As such, an advertiser may be obligated to pay every time a user clicks on the advertisement, at least a portion of which may be payable to the marketplace provider through which the advertiser made the bid.

Ranking of sponsored search advertisements may relate to the order in which the advertisements are shown on a user's display. Generally, a higher ranked advertisement will obtain a higher click through rate (CTR). Bid amounts may influence ranking of advertisements, so that a higher bid amount will generally lead to a higher rank, although other factors may also be involved in determining rank.

In such arrangements, although advertisers may pay on a per click basis, often what is truly important, or most important, to the advertisers are conversions. What an advertiser deems a conversion may differ based on various different circumstances, but often a conversion is a user action that produces profit or value to the advertiser, such as, for example, a purchase.

As mentioned above, advertisements are matched to user keyword queries. However, various types and qualities of matching exist. For instance, an exact match may occur when a user-entered query exactly matches the keyword phrase that an advertiser bid on. Of course, there are a great many possible keyword queries that a user may enter, and it may be impractical or otherwise undesirable for an advertiser to bid on each of them individually. Instead, an advertiser may wish to bid a group of keyword queries, so that if any query in that group is entered, a specified advertisement, or an advertisement of a specified nature or group, is served. For instance, an advertiser may bid in connection with a specific keyword phrase, but may authorize an advertisement to be served in connection with any of a group of keyword queries. The group may, for instance, be determined by the marketplace provider and may, for instance, all be related or considered similar to or associated with the specific keyword phrase. However, non-exact matched advertisements may not perform the same as exact-matched advertisements. Furthermore, different degrees of quality may exist between different matches including different non-exact matches.

There is a need for methods and systems that allow for advertiser bidding that reflects or better reflects advertisement performance or predicted advertisement performance.

### SUMMARY

In some embodiments, methods and systems are provided for adjusting an advertiser bid, in a sponsored search auction, in connection with one or more advertisements to be served in connection with keyword queries, the bid being associated with one or more keyword phrases. The bid may be adjusted based on a predicted conversion rate associated with an advertisement served in connection with a match between a keyword query and the one or more keyword phrases. A bid may be decreased for a match with a lower predicted conversion rate than a comparison predicted conversion rate such as a normalized average predicted conversion rate.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a flow diagram of a method according to one embodiment of the invention; and

FIG. 4 is a conceptual block diagram according to one embodiment of the invention.

While the invention is described with reference to the above drawings, the drawings are intended to be illustrative, and the invention contemplates other embodiments within the spirit of the invention.

### DETAILED DESCRIPTION

Often times, in sponsored search advertising arrangements, an advertiser has an agreement with an entity that facilitates or helps facilitate the advertiser's advertising campaign. Such an agreement may include terms whereby, for example, an advertiser agrees to pay per user click on an appropriate impression (although embodiments of the invention are not limited to such contexts or arrangements). An appropriate impression may occur anytime a suitable advertisement is served to a user under the terms of the agreement.

Such agreements may specify certain advertisements, or groups or variations of advertisements, be served only if certain criteria are met, such as targeting criteria. In sponsored search, typically, an advertiser specifies a bid, a range of bids, or a maximum bid, in connection with a keyword phrase, or group of phrases, associated with a keyword search query, or group of queries, that may be entered by users. Of course, online advertising campaigns can be huge, and advertisers may use proxies, automated systems, programs, or other tools to make or help make such arrangements, bids etc. The amount of the bid may influence the rank or position of the advertisement as served to a user, which in turn may influence performance of the advertisement, including the probability of a click by a user.

A bid may, for example, represent an amount that the advertiser is prepared or willing to pay per user click (or other selection) on an appropriately served advertisement (or one of a group of advertisements, etc.) that matches a query entered by the user. A matching query may be a query that is considered to match the keyword phrase or group of phrases that was specified in connection with the advertiser's bid.

The amount of accepted bids may determine or directly influence how advertiser's spend is allocated, and is therefore generally very important to the performance and return on investment associated with online advertising campaigns. As such, optimization with respect to bidding is typically critical to advertisers. Ideally, advertisers wish to bid on particular opportunities so that, for their spend, their return on investment, or advertising goals, are maximized or met to the highest degree possible.

In particular, for example, the amount that an advertiser bids in connection with a particular keyword phrase may influence whether the bid is accepted under various circumstances, and what positional rank the advertisement obtains when served to a user (although other factors may also be involved and influence rank). Of course, the bid may also determine how much the advertiser pays for a click on the advertisement served. In what can be a delicate balance, the advertiser wants to bid that amount that will lead to the greatest benefit from the spend, and, in the larger picture, the most effective advertising campaign for the total spend associated with the campaign.

While the advertiser may pay based on clicks, for example, often what the advertiser wants, or wants the most, are conversions. What constitutes a conversion may differ from advertiser to advertiser, and may depend on the desires of the advertiser, the goals of the campaign, the product or service area that may be associated with the advertisement, etc. However, in the final analysis, the advertiser may wish to optimize return on investment with regard to conversions, or conversions may at least play a large role in measuring the value of the spend.

As such, while the advertiser may pay, for example, per click, it is ultimately the number of conversions (perhaps also influenced by type or magnitude thereof) that may be a thing, or the thing, that is really important to them. As such, the probability, or estimated or forecasted probability, of a conversion (per click) may play an important factor in determining what an optimal bid is for a particular opportunity, such as a bid associated with a specific keyword phrase or group of phrases.

However, not all matches leading to clicks, or other actions, lead to the same predicted or predictable probability of conversion. For example, conversion rates associated with an exact match may differ from conversion rates associated with a broad match.

An exact match is generally defined by a marketplace provider as occurring when a user-entered query is considered identical or nearly identical to a bidding phrase, with certain variations being allowed as specified by a marketplace provider, generally including singular and plural variations of a term or terms of the query, recognized misspellings of a term or terms of the query, and generally non-material words such as articles like “a” and “the” and prepositions. A broad match (which might be named differently by different marketplace providers) is generally defined by a marketplace provider as occurring anytime a user enters a query that is sufficiently similar to the bidded phrase, with the marketplace provider generally determining the criteria necessary for sufficient similarity. As a simple example, the query “black IPOD cases” may be considered an exact match to the bidded phrase “black IPOD case”. The queries “red IPOD case” and “black IPOD accessories” may be considered to match under a broad match standard, although they are non-exact matches. Other examples of types of non-exact matching exist as well. For instance, non-exact matching may be based on, or based primarily on, matching between a user query and advertiser listing.

However, as mentioned, not all matching queries may lead to the same conversion rates. For instance, an exact match may lead to a high conversion rate, while a non-exact match, such as a match that qualifies under a broad match standard, may lead to a lower conversion rate. This may be because different matches are differently aligned with the particular user's intent, or for other reasons. Furthermore, particular matches may lead to different conversion rates, depending on a range of match variables, including variables external to the query and bidded phrases themselves, such as associated advertisement characteristics, advertiser characteristics, user characteristics, and other variables.

In some existing systems, advertisers may be able to specify a bid, or bidding parameters, with insufficient granularity with respect, for instance, to factors influenced by the match, match type or quality. For instance, advertisers may not be able to specify a bid for a non-exact match, such as a broad match. The bid may apply to an exact match and any qualifying non-exact match. In such systems, while the quality of the match and other factors may influence conversion rates, the advertiser must specify a single bid, or a single set of bidding parameters, for any match. Therefore, even if different conversion rates may be involved, the advertiser must specify only one bid or set of bid parameters associated with the entire group of matches. As such, a bid may be overly high for a low quality match with a relatively low anticipated conversion rate, but overly low for a high quality match.

While it may not be possible to know future conversion rates precisely, it is possible to make predictions based on relevant criteria. For example, machine learning algorithms and models can be used to determine predicted conversion rates.

In some embodiments of the invention, predicted conversion rates are determined, such as by use of machine learning models or algorithms. In some embodiments, a marketplace provider or advertising campaign facilitator may make or help make the determination. The marketplace provider may make use of a large database of information, including information relating to historical performance of the advertisement in question, other advertisements in an advertisement group associated with the advertisement, the associated advertising campaign, other advertisers' advertisement campaigns, user targeting or other information associated with a particular match, and other information. The information may be used with a machine learning technique in order to determine predicted conversion rates. In some embodiments, advertisers may be informed and may agree to such marketplace provider activities or services.

The predicted conversion rates may then be used to influence bidding. For example, if an advertiser specifies a bid or set of bidding parameters in connection with a broad match, low predicted conversion rates for non-exact matches may lead to downward adjustment of the bid for such matching instances. Furthermore, some embodiments, bids may be upwardly adjusted for matches with high predicted conversion rates, which may be the case for exact matches. Furthermore, in some embodiments, a predicted conversion rate for a match may be compared with a pertinent average predicted conversion rate, such as an average conversion rate that is normalized at some level, as discussed further below.

For example, in some embodiments, a bid may be lowered or raised depending on the predicted conversion rate of a particular match, perhaps up to a maximum bid. Furthermore, bids may be adjusted to a degree that corresponds or is otherwise linked to, such as by algorithm, the predicted conversion rate (or range of rates) associated with the match.

In some embodiments, whether and by how much bids are adjusted may be influenced by other factors, such as how much, in what ways, it is desired to influence or allow influence of the marketplace. Furthermore, in some embodiments, bids are adjusted only if an anticipated conversion rate is sufficiently different, such as by being at or beyond a certain threshold percentage, from a conversion rate with which it is compared, such as an applicable average conversion rate.

In some embodiments, bid adjustments downward can be effectively spread out or distributed selectively. For example, instead of simply and evenly reducing bids based on lower predicted conversion rates, in some embodiments, bids are only adjusted downward if a predicted conversion rate is beyond a certain threshold below an average or other comparison conversion rate. This can be viewed as having the effect of spreading out the downward adjustments among cases most suited for it.

Furthermore, in some embodiments, factors other than conversions may be of some importance to advertisers, and this can be worked into a bid adjustment allocation scheme. For instance, some advertisers may place a certain value on number of clicks or impressions, perhaps for brand recognition, etc., even if conversions are the most important thing to them. As such, the return on investment for such advertisers may be based on conversions as well as other factors. To account or help for this, a bid adjustment scheme can be tailored to reflect optimization with regard to a combination of these or other factors, including predicted conversion rate as well as one or more other factors, such as impressions or clicks. For example, if a certain match type or quality is likely to lead to more clicks, this, as well as predicted conversion rates, can be worked into bid adjustment thresholds or other types or degrees of bid adjustment, relative to predicted conversion rates.

By adjusting bids according to differing predicted conversion rates, embodiments of the invention can have a dramatic effect on positively influencing and optimizing advertiser campaigns. In particular, for instance, better converting advertisements will tend to be ranked higher, and vice versa. This will lead, overall, to more conversions. Better advertiser campaign performance will lead to greater advertiser involvement and spend. Furthermore, a more optimal marketplace will result overall, leading to greater profitability for involved parties, including the marketplace operator or advertising campaign facilitator. For example, cost per click for lower converting advertisements will tend to be lower, etc. In addition, marketplace quality overall will be higher, and fairness will be increased. Still further, user satisfaction and participation will be increased, due to a better user experience being provided.

As mentioned, in some embodiments, machine learning techniques are used in predicting click or conversion rates. For example, machine learning techniques such as linear regression or logistic regression, as well as other techniques and models, may be used. In some embodiments, some advertisers Web sites are set up to allow conversion tracking. For example, in some embodiments, advertisers may opt in to have their conversions, and rates, tracked and communicated to a marketplace provider or a database accessible thereto. This database may then be utilized in providing information to be used in application of the machine learning techniques.

As mentioned above, different advertisers may have different definitions or standards with regard to what constitutes a conversion. As such, it may not be possible to directly equate, utilize, or compare conversion data, such as in application of machine learning techniques and conversion rate prediction. However, in some embodiments, such data may be normalized at any of various levels, in order to allow better use of the data. The level of normalization may be used in determining what an average conversion rate is, for a particular situation. Predicted conversion rates may then be compared to the average, and this ratio may be used to determine or influence bid adjustment.

For instance, in some embodiments, historical and tracked campaign information may be used. All conversions for a particular advertiser may be statistically normalized with an average conversion rate for that advertiser. Machine learning techniques can then be used in analyzing differences between different subset of clicks, and then applying that to better predict conversion rates associated with particular future matches.

Besides the advertiser level, normalization is possible at other levels as well. For example, in some embodiments, normalization is accomplished at levels such as an advertiser bidded term level, a level associated with a group of similar bidded terms such as bidded terms with similar commercial intent, or other levels, such as an ad group level, campaign level, etc. Furthermore, other variations and degrees of granularity are possible, such as normalization at a particular level, but only, for example, considering exact match clicks, or normalization with regarding to advertisers or advertisements considered to be similar in some way, such as by having or being associated with similar conversion rates, etc.

In some embodiments, with regard to a machine learning model, feature types and information, such as conversion feedback feature types and information, are determined and selected that influence or impact match quality. For example, information about a user may be captured through features taking into account the user's current query, and other behavior such as the user's past queries, clicks, etc. Furthermore, information can be used relating to or directly relating to the quality of the match made by the matching system, such as click probability in connection with the type of advertisement involved, whether the query is an exact match with the bidded phrase or any other type of match, a match quality or confidence score that may be available or generated from the matching system, the quality of a syntactical or other relevance score, etc. Other information utilized can include past click and other behavior of the particular user other similar users, the same or a similar advertisement of group of advertisements, the same or similar advertiser or group of advertisers, the same or similar user or group of used, etc. Still further, information can be utilized relating to the advertisement and bid landscape for the particular user query, bid amount information relating to other advertisements, etc.

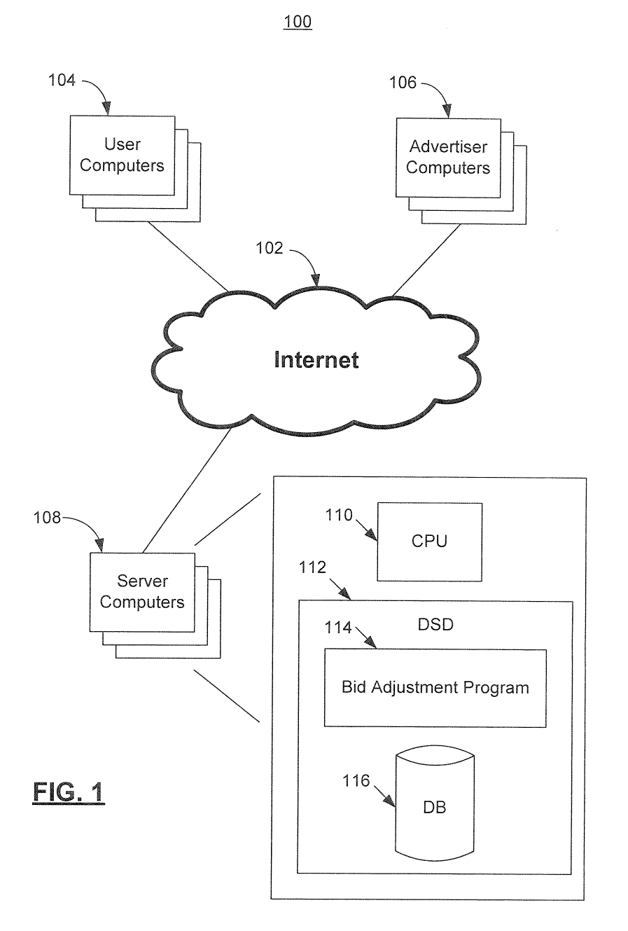

FIG. 1 is a distributed computer system 100 according to one embodiment of the invention. The system 100 includes user computers 104, advertiser computers 106 and server computers 108, all connected or connectable to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context.

As depicted, each of the server computers 108 includes one or more CPUs 110 and a data storage device 112. The data storage device 112 includes a database 116 and a bid adjustment program 114.

The bid adjustment program 114 is intended to broadly include all programming, applications, software and other and tools necessary to implement or facilitate methods and systems according to embodiments of the invention. In various embodiments, methods and systems according to embodiments of the invention may exist on a single computer or device or may be distributed among multiple computers of devices.

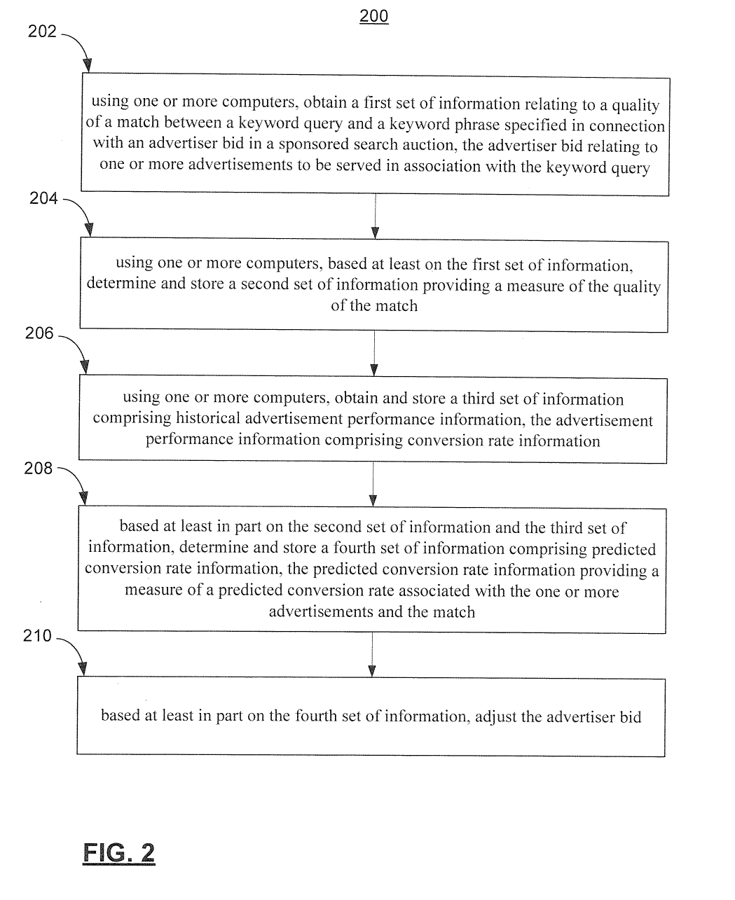

FIG. 2 is a flow diagram of a method 200 according to one embodiment of the invention. At step 202, using one or more computers, a first set of information is obtained relating to a quality of a match between a keyword query and a keyword phrase specified in connection with an advertiser bid in a sponsored search auction, the advertiser bid relating to one or more advertisements to be served in association with the keyword query.

Next, at step 204, using one or more computers, based at least on the first set of information, a second set of information is determined and stored, the second set of information providing a measure of the quality of the match.

Next, at step 206, using one or more computers, a third set of information is obtained and stored, the third set of information including historical advertisement performance information, the advertisement performance information including conversion rate information.

Next, at step 208, based at least in part on the second set of information and the third set of information, a fourth set of information is determined and stored, the fourth set of information including predicted conversion rate information, the predicted conversion rate information providing a measure of a predicted conversion rate associated with the one or more advertisements and the match.

Finally, at step 210, based at least in part on the fourth set of information, the advertiser's bid is adjusted.

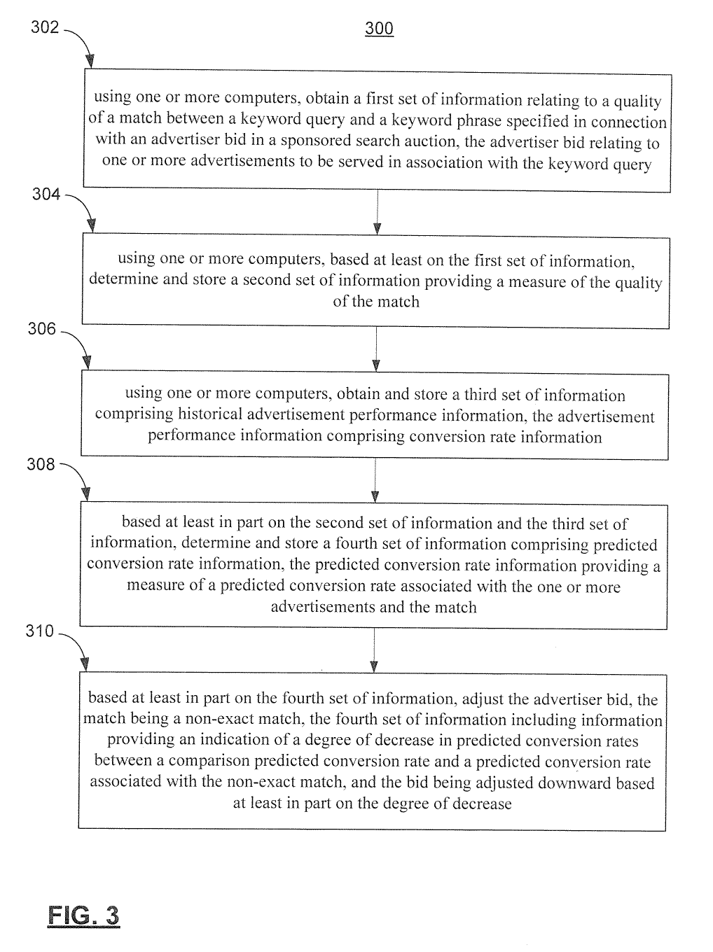

FIG. 3 is a flow diagram of a method 300 according to one embodiment of the invention. Steps 302-308 of FIG. 3 are similar to steps 202-208 of FIG. 2.

At step 310, based at least in part on the fourth set of information as determined at step 308, the advertiser bid is adjusted, the match being a non-exact match, the fourth set of information including information providing an indication of a degree of decrease in predicted conversion rates between a comparison predicted conversion rate and a predicted conversion rate associated with the non-exact match, and the bid being adjusted downward based at least in part on the degree of decrease.

For example, step 310 can apply in a situation where an advertiser specifies bid in a broad match context. The comparison predicted conversion rate may be, for example, a pertinent normalized average conversion rate, such as a normalized predicted conversion rate pertaining to a set of clicks in some way associated with the present click.

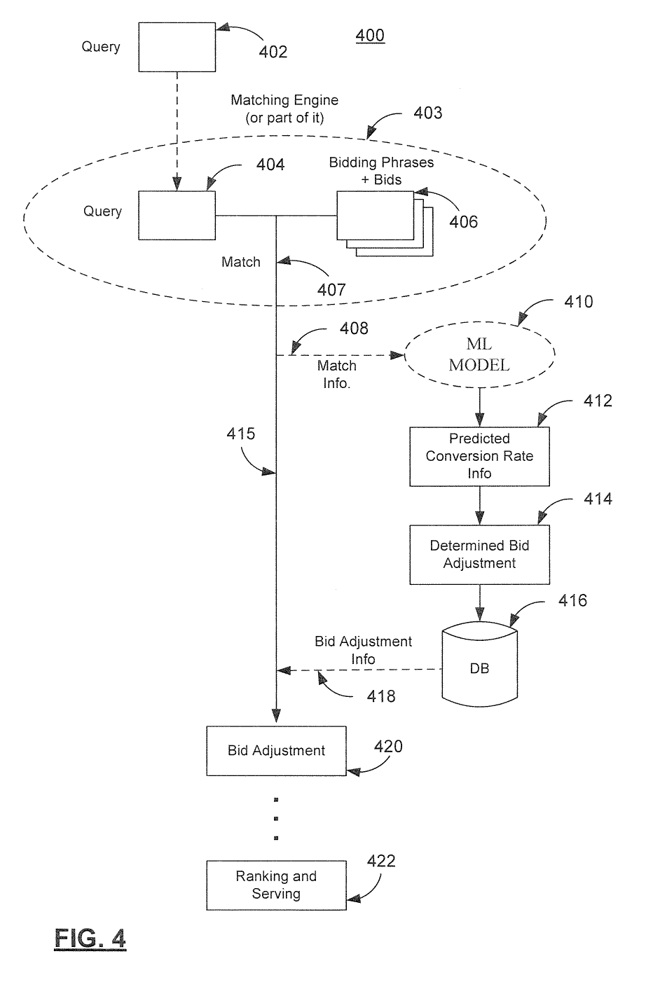

FIG. 4 is a conceptual block diagram 400 according to one embodiment of the invention. Block 402 represents a user query, such as a keyword search query. Block 404 represents the query received by a sponsored search matching engine 403. Block 406 represents bidding phrases with which queries may be matched, and advertiser bids associated therewith.

Arrow 407 represents a process that begins with the matching of the query 404 with an appropriate advertisement that has a bidded phase and bid. While matching of a keyword query and a keyword phrase is often referred to herein, it is to be understood that other information may be utilized in matching, such as content of the advertisement creative, an associated landing page URL, etc. Arrow 408 represents sending of match information, which can include advertiser information, advertisement information, user information, etc., associated with the match, to a machine learning model 410. Block 412 represents predicted conversion rates as determined by the model 410, which can include, for example, a predicated conversion rate associated with the match, and a comparison normalized (at some level) average predicted conversion rate. Block 414 represents a bid adjustment as determined using the model 410, such as by comparison of the predicted conversion rate associated with the match to the comparison normalized average predicted conversion rate. Information including the determined bid adjustment 414 is stored in a database 416. It is to be understood that, in some embodiments, information including the bid adjustment 414 may be computed in real time, and not pre-computed.

Arrow 418 represents sending of the bid adjustment information to be used in the process indicated by arrow 407. Block 420 represents bid adjustment in accordance with the bid adjustment information. Finally, block 422 represents eventual serving of an advertisement in accordance at least with the match and the associated bid as adjusted in accordance with the bid adjustment.

The foregoing description is intended merely to be illustrative, and other embodiments are contemplated within the spirit of the invention.

What is claimed is:

1. A method comprising:
using one or more computers, obtaining a first set of information relating to a quality of a match between a keyword query and a keyword phrase specified in connection with an advertiser bid in a sponsored search auction, the advertiser bid relating to one or more advertisements to be served in association with the keyword query;
using one or more computers, based at least on the first set of information, determining a second set of information providing a measure of the quality of the match;
using one or more computers, storing the second set of information;
using one or more computers, obtaining a third set of information comprising historical advertisement performance information, the advertisement performance information comprising conversion rate information;
using one or more computers, storing the third set of information;
using one or more computers, based at least in part on the second set of information and the third set of information, determining a fourth set of information comprising predicted conversion rate information, the predicted conversion rate information providing a measure of a predicted conversion rate associated with the one or more advertisements and the match;
using one or more computers, storing the fourth set of information; and
based at least in part on the fourth set of information, adjusting the advertiser bid.

2. The method of claim 1, wherein:
the match is a non-exact match;
the fourth set of information comprises information providing an indication of a degree of decrease in predicted conversion rates between a comparison predicted conversion rate and a predicted conversion rate associated with the non-exact match; and
the bid is adjusted downward based at least in part on the degree of decrease.

3. The method of claim 2, wherein the fourth set of information comprises information providing an indication of a degree of decrease in predicted conversion rates between a comparison predicted conversion rate and a predicted conversion rate associated with the non-exact match, and wherein the comparison predicted conversion rate is a normalized average predicted conversion rate.

4. The method of claim 3, comprising using a machine learning technique in determining the second set of information.

5. The method of claim 4, comprising using a linear regression technique in determining the second set of information.

6. The method of claim 2, comprising using a machine learning model that uses features relating to match quality.

7. The method of claim 6, comprising using a machine learning model that uses historical advertising information relating to the advertiser and a user that enters the keyword query.

8. The method of claim 7, comprising using a machine learning model that uses historical information relating to advertisement campaigns of other advertisers.

9. The method of claim 1, wherein a greater decrease in the predicted conversion rates leads to a greater decrease in the bid.

10. A system comprising:
one or more server computers connected to the Internet; and
one or more databases connected to the one or more servers;
wherein the one or more server computers are for:
obtaining a first set of information relating to a quality of a match between a keyword query and a keyword phrase specified in connection with an advertiser bid in a sponsored search auction, the advertiser bid relating to one or more advertisements to be served in association with the keyword query;
based at least on the first set of information, determining a second set of information providing a measure of the quality of the match;
storing the second set of information in at least one of the one or more databases;
obtaining a third set of information comprising historical advertisement performance information, the advertisement performance information comprising conversion rate information;
storing the third set of information in at least one of the one or more databases;
based at least in part on the second set of information and the third set of information, determining a fourth set of information comprising predicted conversion rate information, the predicted conversion rate information providing a measure of a predicted conversion rate associated with the one or more advertisements and the match;
storing the fourth set of information in at least one of the one or more databases; and
based at least in part on the fourth set of information, adjusting the advertiser bid;

11. The system of claim 9, wherein:
the match is a non-exact match;
the fourth set of information comprises information providing an indication of a degree of decrease in predicted conversion rates between a comparison predicted conversion rate and a predicted conversion rate associated with the non-exact match; and
the bid is adjusted downward based at least in part on the degree of decrease.

12. The system of claim 11, comprising using a machine learning technique in determining the second set of information.

13. The system of claim 12, comprising using a linear regression technique.

14. The system of claim 11, comprising using a machine learning model that uses features relating to match quality.

15. The system of claim 14, comprising using a machine learning model that uses historical information relating to advertisement campaigns of other advertisers.

16. The system of claim 11, wherein a greater decrease in the predicted conversion rates leads to a greater decrease in the bid.

17. The system of claim 11, comprising using a machine learning model that uses conversion rate information associated with an advertisement group in which the one or more advertisements are included.

18. A computer readable medium or media containing instructions for executing a method, the method comprising:
using one or more computers, obtaining a first set of information relating to a quality of a match between a keyword query and a keyword phrase specified in connection with an advertiser bid in a sponsored search auction, the advertiser bid relating to one or more advertisements to be served in association with the keyword query;
using one or more computers, based at least on the first set of information, determining a second set of information providing a measure of the quality of the match;
using one or more computers, storing the second set of information;
using one or more computers, obtaining a third set of information comprising historical advertisement performance information, the advertisement performance information comprising conversion rate information;
using one or more computers, storing the third set of information;
using one or more computers, based at least in part on the second set of information and the third set of information, determining a fourth set of information comprising predicted conversion rate information, the predicted conversion rate information providing a measure of a predicted conversion rate associated with the one or more advertisements and the match;
using one or more computers, storing the fourth set of information; and
based at least in part on the fourth set of information, adjusting the advertiser bid;
wherein:
the match is a non-exact match;
the fourth set of information comprises information providing an indication of a degree of decrease in predicted conversion rates between a comparison predicted conversion rate and a predicted conversion rate associated with the non-exact match, wherein the comparison predicted conversion rate is a normalized average predicted conversion rate; and
the bid is adjusted downward based at least in part on the degree of decrease.

19. The computer readable media of claim 18, comprising using a machine learning technique in determining the second set of information.

20. The computer readable media of claim 19, comprising using a linear regression technique in determining the second set of information.
